(19) United States
(12) Patent Application Publication
(10) Pub. No.: US 2004/0090200 A1
(43) Pub. Date: May 13, 2004

(54) Power supply apparatus for motor and control method thereof

(75) Inventor: Jang-Hyoun Youm, Suwon-city (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon City (KR)

(21) Appl. No.: 10/630,837

(22) Filed: Jul. 31, 2003

(30) Foreign Application Priority Data
Nov. 8, 2002 (KR) 2002-69168

(51) Int. Cl. H02P 7/00

(52) U.S. Cl. 318/434

(57) ABSTRACT

A power supply apparatus for a motor including an AC power supply, a diode rectifier circuit to rectify power of the AC power supply and a DC capacitor to smooth the rectified power, comprising a current limiting part provided between the AC power supply and the DC capacitor; a connection switching part to switch a connection state of the diode rectifier circuit and the current limiting part; a controller to control the connection switching part so that the diode rectifier circuit and the current limiting part are connected to each other one of in parallel and in series. Thus, an inrush current protection circuit and an over voltage protection circuit use a single resistor according to their respective functions.

### CROSS-REFERENCE TO RELATED APPLICATION

This application claims the benefit of Korean Application No. 2002-69168, filed Nov. 8, 2002, in the Korean Intellectual Property Office, the disclosure of which is incorporated herein by reference.

### BACKGROUND OF THE INVENTION

1. Field of the Invention

The present invention relates to a power supply apparatus, and more particularly to a power supply apparatus for a motor and a control method thereof having an inrush current protection circuit.

2. Description of the Related Art

A three-phase motor has a coil with a triangular winding. A power supply apparatus for the three-phase motor, as shown in FIG. 5, supplies a three-phase voltage necessary to drive an AC motor 117 and comprises an AC power supply 101 to supply commercial AC voltage (AC110/220V), a diode rectifier part 103 to rectify the commercial AC voltage, an inrush current protection circuit 102 and 111 to block an inrush current on an initial supply of power, a DC capacitor 115 to smooth the rectified AC voltage from the diode rectifier part 103, an over voltage protection circuit 112 and 114 to protect the DC capacitor 115 from an over voltage condition, and an inverter 116 to invert DC voltage to AC voltage having various kinds of frequency and then to output three-phase voltage. In the inverter 116 are provided a PWM (Pulse Width Modulation) part ( ) to generate a PWM signal and a plurality of transistors switched on/off according to a square wave signal of the PWM part. The power supply apparatus for the AC motor 117 further comprises a microprocessor ( ) to control an output of the inverter 116 by turning on/off the plurality of transistors according to a PWM control signal and to control an output frequency so as to control a rotation speed of the AC motor 117.

However, the conventional inrush current protection circuit 102 and 111 of the conventional power supply apparatus for the AC motor 117 operates only when power is initially supplied to a system. That is, once the power is supplied and the DC capacitor 115 is charged, an operation of the conventional inrush current protection circuit 102 and 111 is not necessary to operate the conventional power supply apparatus. Also, the over voltage protection circuit 112 and 114 is operationally needed only in a case that the rectified AC voltage input to the DC capacitor 115 is stabilized (sufficiently charged) to control the motor in view of operation characteristics of the over voltage protection circuit 112 and 114. That is, directly after the power is initially supplied, an operation of the over voltage protection circuit 112 and 114 is not needed. However, a resistor Rs adapted, to the conventional inrush current protection circuit 101 and 111 is used. The resistor Rs can be either a high resistance resistor or a thirmistor so as to block an initial over current condition. As a capacitance of the DC capacitor 115 is increased, a resistance of the resistor Rs is increased and accordingly, a size of a product is increased by an increase in a layout of the conventional inrush current protection circuit.

### SUMMARY OF THE INVENTION

Accordingly, it is an aspect of the present invention to provide a power supply apparatus for a motor and a control method thereof to enable a number of parts and a cost of production to be decreased by reducing a layout size of a circuit thereof by using a resistor for inrush current protection and over voltage protection.

Additional aspects and/or advantages of the invention will be set forth in part in the description which follows and, in part, will be obvious from the description, or may be learned by practice of the invention.

The above and/or other aspects are achieved by providing a power supply apparatus for a motor comprising an AC power supply, a diode rectifier circuit to rectify power of the AC power supply and a DC capacitor to smooth the rectified AC power, a current limiting part provided between the AC power supply and the DC capacitor; a connection switching part to switch a connection state of the diode rectifier circuit and the current limiting part; a controller to control the connection switching part so that the diode rectifier circuit and the current limiting part are connected to each other either in parallel or in series.

The power supply apparatus for the motor may further comprise a detecting part to detect voltage applied between first and second end parts of the DC capacitor.

The current limiting part may include a resistor provided between the AC power supply and the DC capacitor and may be connected to the DC capacitor; the connection switching part may include a relay having a first contact point and a second contact point to allow the diode rectifier circuit and the resistor to be connected to each other, respectively, in parallel and in series; and the controller controls the relay to connect the diode rectifier circuit and the resistor in series in a case that power is supplied initially, and in parallel in a case that the voltage applied between the first and second end parts of the DC capacitor is detected to be more than a predetermined voltage value.

The power supply apparatus for the motor may further comprise an over voltage protection switching part connected to the resistor and provided in parallel with the diode rectifier circuit; and an over voltage protection diode having an anode connected to a contact point of the resistor and the over voltage protection switching part, and a cathode connected to the diode rectifier circuit.

The detecting part may comprise a comparator so as to detect the voltage applied between the first and second end parts of the DC capacitor.

The above and/or other aspects are achieved by providing a control method of a power supply apparatus for a motor comprising an AC power supply, a diode rectifier circuit to rectify power of the AC power supply, a DC capacitor to smooth the rectified AC power, a resistor connected to the DC capacitor and a two-contact relay to allow an end part of the diode rectifier circuit selectively connected to one of the first and second end parts of the resistor by turns, comprising connecting the diode rectifier circuit to the resistor in series so as to charge the DC capacitor, the AC power being supplied initially; detecting a voltage applied between the first and second end parts of the DC capacitor; and connecting the diode rectifier circuit to the resistor in parallel in a case that the detected voltage is more than a predetermined voltage.

### BRIEF DESCRIPTION OF THE DRAWINGS

These and/or other aspects and advantages of the present invention will become apparent and more readily appreciated from the following description of an embodiment, taken in conjunction with the accompanying drawings of which:

FIG. 1 is a view illustrating a circuit of a power supply apparatus for a motor according to an embodiment of the present invention;

FIGS. 2A to 2D are views illustrating voltage and current waveforms at respective contact points of the power supply apparatus for the motor of FIG. 1, with power being initially supplied;

FIGS. 3A to 3D are views illustrating voltage and current waveforms at respective contact points of the power supply apparatus for the motor of FIG. 1, with an over voltage condition occurring;

FIGS. 4A to 4B are graphs illustrating voltage regions where a relay is on and a switching part is turned on; and

FIG. 5 is a view illustrating a circuit of a conventional power supply apparatus for a motor.

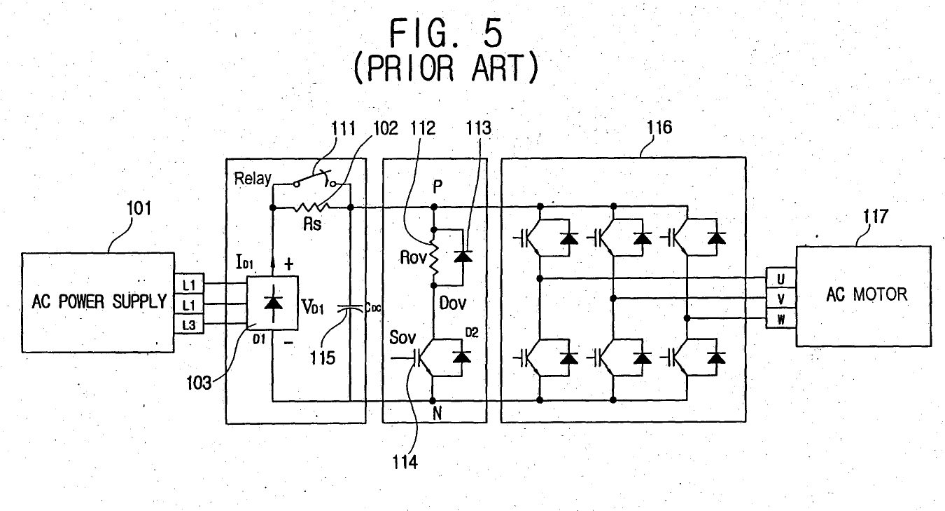

### DETAILED DESCRIPTION OF THE PREFERRED EMBODIMENT

Reference Will now be made in detail to the embodiment of the present invention, examples of which are illustrated in the accompanying drawings, wherein like reference numerals refer to the like elements throughout. The embodiment is described below in order to explain the present invention by referring to the figures.

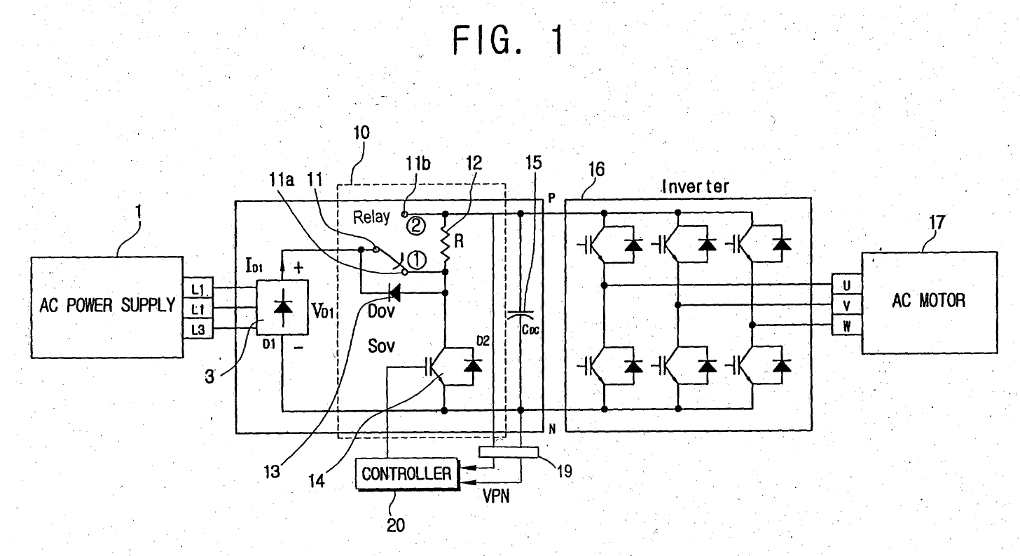

FIG. 1 is a view illustrating a circuit of a power supply apparatus for a motor according to an embodiment of the present invention. As shown in FIG. 1, the circuit of the power supply apparatus for the motor comprises a diode rectifier circuit 3 connected to an AC power supply 1, a resistor 12 and an over voltage protection switching part 14 provided in parallel with the diode rectifier circuit 3, a two-contact relay 11 sequentially connecting an end part of the diode rectifier circuit 3 to one of first and second end parts of the resistor 12, an over voltage protection diode 13 having a cathode connected to the end part of the diode rectifier circuit 3 and an anode connected to a contact point of the resistor 12 and the over voltage protection switching part 14, a DC capacitor 15 provided in parallel with the resistor 12 and the over voltage protection switching part 14, an inverter 16 provided in parallel with the DC capacitor 15, and a controller 20 to control the two-contact relay 11. The circuit of the power supply apparatus for the motor further comprises a detecting part 19 to detect a voltage applied between first and second end parts of the DC capacitor 15 and to provide a signal corresponding to the detected voltage to the controller 20. A comparator is used as the detecting part 19.

The resistor 12, the two-contact relay 11 and the over voltage protection diode 13 operate as an inrush current and over voltage protection circuit 10.

An operation process of the circuit of the power supply apparatus for the motor will be described as follows. When power is initially supplied, the diode rectifier circuit 3 is connected to a first contact point 11a provided to the first end part of the resistor 12 by the two-contact relay 11 and is operated as an inrush current protection circuit. Thus, the DC capacitor 15 is charged with a current of the diode rectifier circuit 3 through the resistor 12 connected to the two-contact relay 11.

In a case that the charging of the DC capacitor 15 is completed and thus a voltage of the DC capacitor 15 is above a predetermined voltage, the controller 20 applies a control signal to the two-contact relay 11 and controls the diode rectifier circuit 3 to connect to a second contact point 11b provided to the second end part of the resistor 12. Accordingly, rectified input power is directly applied to the DC capacitor 15. The resistor 12 connected to the two-contact relay 11, the over voltage protection diode 13 and the over voltage protection switching part 14 are operated as an over voltage protection circuit. An operation principle of the over voltage protection circuit is described as follows. The controller 20 detects Vpn, voltage applied between the first and second end parts of the DC capacitor 15 by a comparator ( ), and if the Vpn is larger than a predetermined voltage, a current is generated corresponding to over voltage of the DC capacitor 15. Thus,,energy related to the over voltage condition is transformed to thermal energy through the resistor 12.

A control process of the controller 20 for inrush current and over voltage protection implemented by the power supply apparatus for the motor having a structure of FIG. 1 is as follows. As shown in FIG. 1, the power is initially supplied from the AC power supply 1, and a control signal is applied to the two-contact relay 11 to connect the diode rectifier circuit 3 and the resistor 12 in series, and thus the DC capacitor 15 is slowly charged with the current inputted through the resistor 12. After the DC capacitor 15 is completely charged, if the voltage of the DC capacitor 15 is more than a predetermined over voltage reference value, the control signal is provided to the two-contact relay 11 to connect the diode rectifier circuit 3 and the resistor 12 in parallel, so that the over voltage condition of the DC capacitor 15 is corrected by energy related to the over voltage condition being transformed to thermal energy through the resistor 12.

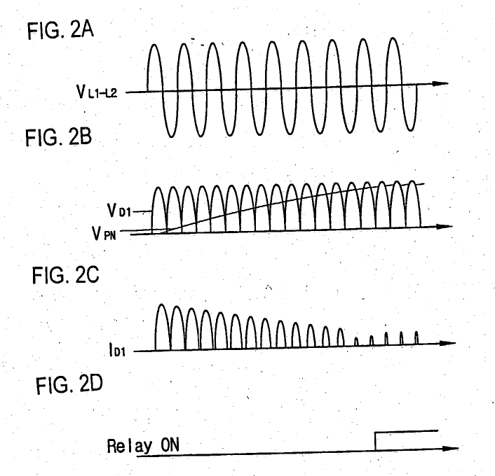

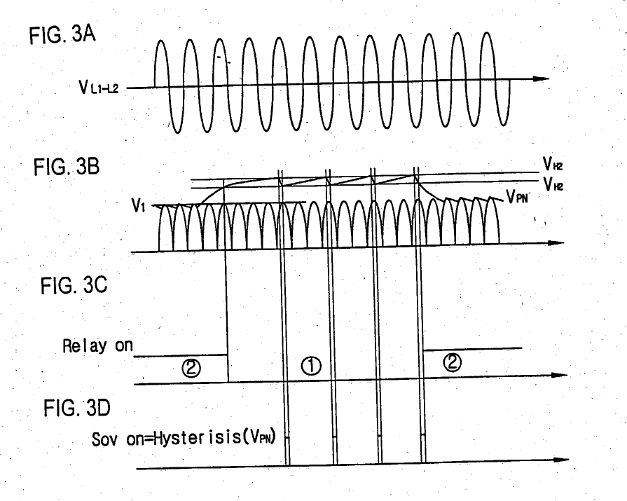

As shown in FIGS. 2A-2D and 3A-3D, an AC input power is a sine wave in which positive and negative voltages are alternated (refer to FIG. 3A). The AC input power is rectified through the diode rectifier circuit 3 and then the rectified power is inputted through the resistor 12. As the rectified power is inputted through the resistor 12, the DC capacitor 15 is gradually charged and has a voltage curve gradually increasing. However, if the voltage of the DC capacitor 15 is more than a predetermined over voltage reference value, as shown in FIGS. 3A-3D, the controller 20 actuates the two-contact relay 11 (refer to FIG. 3C) and makes the over voltage protection switching part 14 switch on/off (refer to FIG. 3D) so as to make the diode rectifier circuit 3 connect to the second contact point 11b. Accordingly, the Vpn, the voltage applied to the DC capacitor 15, is represented in a decreasing form (refer to FIG. 3B).

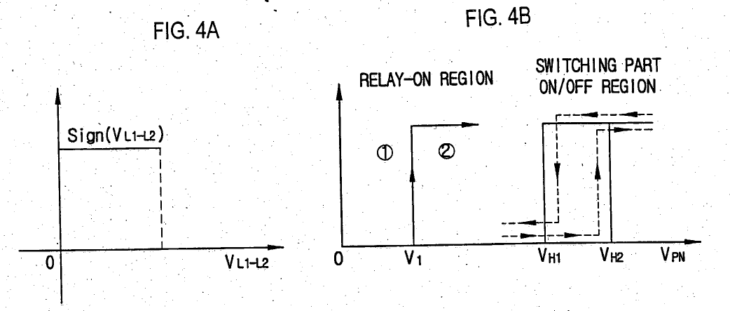

FIG. 4A and 4B are graphs illustrating voltage regions where a relay is on and a over voltage protection switching part is turned on. The controller 20, if the voltage of the DC capacitor 15 is increased to be at a relay driving voltage V1, makes the two-contact relay 11 on, and if the voltage of the DC capacitor 15 is increased to be at an over voltage upper limit Vh2 by energy provided from the AC motor 17, turns on the over voltage protection switching part 14, to, thereby consume energy through the resistor 12 which corresponds to the over voltage condition. Thus, if the voltage of the DC capacitor 15 is lower than an over voltage lower limit Vh1, the controller 20 turns off the over voltage protection switching part 14. Whenever the voltage of the DC capacitor 15 enters the over voltage condition region between the voltage lower limit Vh1 and the over voltage upper limit Vh2, the controller 20 turns on/off the over voltage protection switching part 14, to thereby stabilize the voltage of the DC capacitor 15.

A conventional inrush current protection circuit used only when power is initially supplied and an over voltage protection circuit used only when charged voltage of a DC capacitor is more than a predetermined voltage, are implemented to have respective resistors. However, according to the embodiment of the present invention, an inrush current protection circuit and an over voltage protection circuit using a single resistor are implemented and use the single resistor according to respective functions thereof, to thereby decrease a number of parts, a size of a product and a cost of production of the circuit.

As described above, according to the present invention, provided is a power supply apparatus for a motor and a control method thereof to enable a number of parts and cost of production to be decreased based on an improved layout of the circuit by using a single resistor for not only inrush current protection but also for over voltage protection.

Although an embodiment of the present invention has been shown and described, it will be appreciated by those skilled in the art that changes may be made in this embodiment without departing from the principles and spirit of the invention, the scope of which is defined in the appended claims and their equivalents.

What is claimed is:

1. A power supply apparatus for a motor including an AC power supply, a diode rectifier circuit to rectify power of the AC power supply and a DC capacitor to smooth the rectified power, comprising:
a current limiting part provided between the AC power supply and the DC capacitor;
a connection switching part to switch a connection state of the diode rectifier circuit and the current limiting part; and
a controller to control the connection switching part so that the diode rectifier circuit and the current limiting part are connected to each other selectively in parallel or in series.

2. The power supply apparatus for the motor according to claim 1, further comprising:
a detecting part to detect voltage applied between first and second end parts of the DC capacitor.

3. The power supply apparatus for the motor according to claim 1, wherein:
the current limiting part comprises:
a resistor provided between the AC power supply and the DC capacitor and connected to the DC capacitor; and
the connection switching part comprises:
a relay having a first contact point and a second contact point to allow the diode rectifier circuit and the resistor to be connected to each other selectively in parallel or in series, and the controller controls the relay to connect the diode rectifier circuit and the resistor in series when the power is supplied initially, and to connect the diode rectifier circuit and the resistor in parallel when the voltage applied between the first and second end parts of the DC capacitor is more than a predetermined voltage.

4. The power supply apparatus for the motor according to claim 2, wherein:
the current limiting part comprises:
a resistor provided between the AC power supply and the DC capacitor and connected to the DC capacitor; and
the connection switching part-comprises:
a relay having a first contact point and a second contact point to allow the diode rectifier circuit and the resistor to be connected to each other selectively in parallel or in series, and the controller controls the relay to connect the diode rectifier circuit and the resistor in series when the power is supplied initially, and to connect the diode rectifier circuit and the resistor in parallel when the voltage applied between the first and second end parts of the DC capacitor is more than a predetermined voltage.

5. The power supply apparatus for the motor according to claim 3, further comprising:
an over voltage protection switching part connected to the resistor and provided in parallel with the diode rectifier circuit; and
an over voltage protection diode having an anode connected to a contact point of the resistor and the over voltage protection, switching part, and a cathode connected to the diode rectifier circuit.

6. The power supply apparatus for the motor according to claim 4, further comprising:
an over voltage protection switching part connected to the resistor and provided in parallel with,the diode rectifier circuit; and
an over voltage protection diode having an anode connected to a contact point of the resistor and the over voltage protection switching part, and a cathode connected to the diode rectifier circuit.

7. The power supply apparatus for the motor according to claim 4, wherein the detecting part comprises:
a comparator so as to detect the voltage applied between the first and second end parts of the DC capacitors.

8. The power supply apparatus for the motor according to claim 6, wherein the detecting part comprises:
a comparator so as to detect the voltage applied between the first and second end parts of the DC capacitor.

9. A control method of a power supply apparatus for a motor including an AC power supply, a diode rectifier circuit to rectify power of the AC power supply, a DC capacitor to smooth the rectified power, a resistor connected to the DC capacitor and a two-contact relay to allow an end part of the diode rectifier circuit selectively connected to one of first and second end parts of the resistor, comprising:
connecting the diode rectifier circuit to the resistor in series so as to charge the DC capacitor when power is supplied initially;
detecting voltage applied between first and second end parts of the DC capacitor; and
connecting the diode rectifier circuit to the resistor in parallel when the detected voltage is more than a predetermined voltage.

10. A power supply apparatus for a motor including an AC power supply, a rectifier circuit to rectify power of the AC power-supply and a smoothing circuit to smooth the rectified power, comprising:
a current limiting part provided between the AC power supply and the smoothing circuit; and
a connection switching part to switch a connection state of the rectifier circuit and the current limiting part so that the rectifier circuit and the current limiting part are connected to each other selectively in parallel or in series.

11. The power supply apparatus for the motor according to claim 10, wherein the smoothing circuit comprises:
a DC capacitor to smooth the AC rectified power, and the power supply apparatus, further comprising:
a detecting part to detect voltage across the DC capacitor of the smoothing circuit.

12. The power supply apparatus for the motor according to claim 10, wherein:
the current limiting part comprises:
a resistor provided between the AC power supply and the smoothing circuit and connected to the smoothing circuit; and
the connection switching part comprises:
a relay having a first node and a second node to connect the rectifier circuit and the resistor, respectively and selectively in parallel or in series.

13. The power supply apparatus for the motor according to claim 10, further comprising:
a controller to control the connection switching part to switch the connection state of the rectifier circuit and the current limiting part so that the rectifier circuit and the current limiting part are connected to each other selectively in parallel or in series.

14. The power supply apparatus for the motor according to claim 10, wherein the current limiting part comprises:
a resistor to be switched by the connection switching part, and the connection switching part comprises:
a relay to connect the rectifier circuit and the resistor in series when the power is supplied initially, and to connect the rectifier circuit and the resistor in parallel when the voltage between the first and second end parts of the smoothing circuit is more than a predetermined voltage.

15. The power supply apparatus for the motor according to claim 14, further comprising:
an over voltage protection switching part connected to the resistor and provided in parallel with the rectifier circuit; and
an over voltage protection diode having an anode connected to a common node of the resistor and the over voltage protection switching part, and a cathode connected to the rectifier circuit.

16. The power supply apparatus for the motor according to claim 11, wherein the detecting part comprises:
a comparator to detect the voltage across the DC capacitor.

17. A power supply apparatus for a motor including an AC power supply, a rectifier circuit to rectify power of the AC power supply and a smoothing circuit to smooth the rectified power, comprising:
a current limiting part comprising:
a resistor such that the current limiting part is provided between the AC power supply and the smoothing circuit;
an over voltage protection part connected to the resistor and provided in parallel with the rectifier circuit; and
a connection switching part to switch the rectified AC power supply to provide one or more of a current limiting protection and an over voltage protection according to a connection state of the connection switching part.

18. A control method of a power supply apparatus for a motor including an AC power supply, a rectifier circuit rectifying power of the AC power supply and a smoothing circuit having a DC capacitor and smoothing the rectified power, a resistor having first and second ends, one of the ends of the resistor being connected to the DC capacitor having first and second ends and a relay allowing the rectifier circuit to be alternatively connected to one of the first and second ends of the resistor, comprising:
supplying power to the motor;
current limiting the supplied power when the power is supplied initially by connecting the rectifier circuit to the resistor in series;
detecting a voltage across the first and second ends of the DC capacitor; and
switching the rectifier circuit and the resistor to a parallel connection when the detected voltage is more than a predetermined voltage.

19. The control method according to claim 18, further comprising:
controlling the switching of a connection state of the rectifier circuit and the resistor so that the rectifier circuit and the resistor are connected to each other selectively in parallel or in series.

20. The control method according to claim 18, further comprising:
protecting the motor from an over voltage condition by connecting an over voltage protection circuit in parallel with the rectifier circuit.

21. The control method according to claim 19, wherein:
the supplying of power to the motor comprises:
charging the DC capacitor with current inputted through the resistor; and
the controlling of the switching comprises:
applying a control signal to the relay to connect the rectifier circuit and the resistor in series when the voltage across the DC capacitor is less than or equal to a predetermined voltage and to connect the rectifier circuit and the resistor in parallel when the voltage across the DC capacitor is more than the predetermined voltage.
